(19) United States
(12) Patent Application Publication
(10) Pub. No.: US 2011/0091176 A1
(43) Pub. Date: Apr. 21, 2011

(54) HOLEY FIBERS

(75) Inventors: Masanori TAKAHASHI, Tokyo (JP); Katsunori Imamura, Tokyo (JP); Kazunori Mukasa, Tokyo (JP); Takeshi Yagi, Tokyo (JP)

(73) Assignee: FURUKAWA ELECTRIC CO., LTD., Tokyo (JP)

(21) Appl. No.: 12/938,104

(22) Filed: Nov. 2, 2010

Related U.S. Application Data
(63) Continuation-in-part of application No. 12/846,113, filed on Jul. 29, 2010.

(30) Foreign Application Priority Data
Aug. 3, 2009 (JP) 2009-181012

(51) Int. Cl. G02B 6/032

(52) U.S. Cl. 385/125

(57) ABSTRACT

A holey fiber with significantly large effective core area is provided. The holey fiber comprises a core portion and a cladding portion at the circumference of the core portion. The cladding portion has plurality of holes distributed to shape triangular lattices around the core portion; wherein d/Λ is less than or equal to 0.42, the diameter of the holey fiber is larger than or equal to 580 μm, an effective core area is larger than or equal to 15000 μm² at 1064 nm and a confinement loss is less than or equal to 0.1 dB/m at 1064 nm; where d is the hole diameter in μm and Λ is a lattice constant of the triangular lattice in μm.

### CROSS-REFERENCES TO RELATED APPLICATIONS

This application is a continuation-in-part application of U.S. application Ser. No. 12/846,113 filed on Jul. 29, 2010, the entire content of this application is incorporated herein by reference.

This application also claims the benefit of priority from Japanese Patent Application No. 2009-181012 filed Aug. 3, 2009, the entire contents of which is incorporated herein by reference.

### TECHNICAL FIELD

The present invention relates to holey fibers.

### BACKGROUND OF THE INVENTION

A holey fiber is a new type of an optical fiber, which has a core portion and a cladding portion at the circumference of the core portion. The cladding portion has plurality of holes distributed around the core portion. The cladding region has the reduced average refractive index because of the presence of the air holes so that a light propagates through the core region by the principle of the total reflection of light. Because the refractive index is controlled by the air holes, the holey fibers can realize unique properties such as endlessly single mode (ESM) and a zero-dispersion wavelength shifted towards extremely shorter wavelengths, which cannot be realized with conventional optical fibers (for example, see K. Saitoh et al., “Empirical relations for simple design of photonic crystal fibers”, OPTICS EXPRESS, Vol. 13, No. 1, pp. 267-274 (2005)). The ESM means that a cut-off wavelength is not present and a light is transmitted in a single mode at all wavelengths. With the ESM, it is possible to realize an optical transmission at a high transmission speed over a broad bandwidth.

A holey fiber can reduce optical nonlinearity by increasing its effective core area. Because of that, holey fibers are started to be considered as a low-nonlinear transmission medium for optical communications or for delivering a high power optical source. Particularly, if a holey fiber is used, an effective core area of larger than or equal to 500 μm² can be achieved. Such large effective core area is hardly achieved by conventional fibers. For example, in M. D. Neilsen et al., “Predicting macrobending loss for large-mode area photonic crystal fibers”, OPTICS EXPRESS, Vol. 12, No. 8, pp. 1775-1779 (2004), a holey fiber (or a photonic crystal fiber) with an effective core area of larger than or equal to 500 μm² is disclosed.

For single-mode optical fibers including holey fibers, increase in the effective core area and reduction of the bending loss have a trade-off relationship (for example, see non-patent literature J. M. Fini, “Bend-resistant design of conventional and microstructure fibers with very large mode area”, OPTICS EXPRESS, Vol. 14, No. 1, pp. 69-81 (2006)).

Because increase in the effective core area of the holey fiber and reduction of the bending loss have the trade-off relationship, the effective core area is limited by a reasonable bending loss (for example, less than or equal to 10 dB/m). On the other hand, for optical fibers for high power delivery, optical fiber lasers as high power light sources, and optical fiber amplifiers; holey fibers used for such applications require larger effective core areas and lower optical nonlinearity because of higher power requirement,

### BRIEF SUMMARY OF THE INVENTION

The present invention discloses a holey fiber with significantly large effective core cross-sectional area.

To solve the above issue and to achieve the above purpose, a holey fiber according to the present invention comprises a core portion and a cladding portion at the circumference of the core portion. The cladding portion has plurality of holes distributed to shape triangular lattices around the core portion. d/Λ is less than or equal to 0.42, the diameter of the holey fiber is larger than or equal to 580 μm, an effective core area is larger than or equal to 15000 μm² at 1064 nm and a confinement loss is less than or equal to 0.1 dB/m; where d is the hole diameter in μm and Λ is a lattice constant of the triangular lattice in μm.

### BRIEF DESCRIPTION OF THE DRAWINGS

FIG. 1 is a schematic cross-sectional drawing of a holey fiber relating to a first embodiment;

FIG. 2 is a chart to show a method to calculate the force required to bend the holey fiber;

FIG. 3 is a graph to show the relationship between the diameter of the holey fiber and the force required to bend the holey fiber;

FIG. 4 is a table to show the diameters R_{C}, the confinement losses at 1064 nm and the effective core areas of calculation examples 1˜11, which have the same structure as the holey fiber shown in FIG. 1;

FIG. 5 is a table to show the diameters R_{C}, the confinement losses at 1064 nm and the effective core areas of calculation examples 12˜39, which have the same structure as the holey fiber shown in FIG. 1 but have different number of layers; and

FIG. 6 is a table to show the diameters R_{C}, the confinement losses at 1550 nm and the effective core areas of calculation examples 40˜46, which have the same structure as the holey fiber shown in FIG. 1.

FIG. 7 is a graph indicating the attenuation loss vs. wavelength for a sample holey fiber fabricated according to the present invention.

### DETAILED DESCRIPTION

In the following, detailed description of embodiments of holey fibers according to the present invention is explained by referencing Figures. While various embodiments of the present invention are described below, it should be understood that they are presented by way of examples, and are not intend to limit the applications of the presented invention. In the specification below, holey fibers are shown as HF. Also, if terms are not defined in this specification, those terms are accordance with definitions and measuring methods of International Telecommunication Union Telecommunication Standardization Sector (ITU-T) G.650.1.

### Fast Embodiment

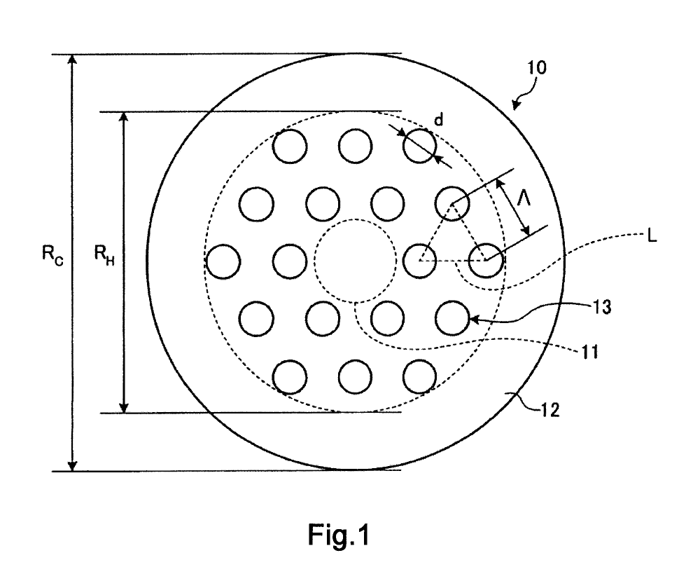

FIG. 1 is a schematic cross section of a holey fiber according to one embodiment of the present invention. As shown in FIG. 1, the HF 10 has a core portion 11 and a cladding portion 12 at the circumference of the core portion 11. The core portion 11 is positioned approximately the center of the cladding portion 12. The core portion 11 and the cladding portion 12 are, for example, both made from pure silica glass, which is not doped with any dopant to control its refractive index.

The cladding portion 12 has plurality of holes 13 around the core portion 11. The holes 13 are distributed as triangular lattices, L. The diameters of the holes 13 are all represented as d (μm), and lattice constants of the triangular lattices, L, in the other word, center distances of the holes 13 are represented as Λ (μm). Also, the holes 13 are distributed to shape layers around the core portion 11. If combinations of the holes 13 placed on each apex and side of an equilateral hexagon are considered as one layer, then this HF 10 has two layers of holes 13. Each equilateral hexagon has the core portion 11 at its center.

In the HF 10, ratio of d and Λ (d/Λ) is 0.42, and A is 120 μm. By setting d/Λ=0.42, as shown in K. Saitoh et al., the HF 10 transmits signals as a single-mode optical fiber for all wavelength including 1064 nm. Also, by setting Λ=120 μm, the HF 10 has a significantly large effective core area of 17710 μm² at 1064 nm. Also, a confinement loss of the HF 10 is 2.86×10⁻⁴ dB/m (which is less than or equal to 0.1 dB/m) at 1064 nm. If less than or equal to 3 m of the HF 10 is used, the HF 10 has a sufficiently small confinement loss. 1064 nm is a common wavelength for such as optical communications using 1.0 μm wavelength band and high power delivery).

If the diameter of the HF 10 is R_{C}, R_{C} is 583 μm. Also, if the area where the holes 13 are distributed is defined at the circumference of the outer most layer of the holes 13, then the diameter of the circumference R_{H} is 530 μm.

Because the effective core area of the HF 10 is significantly large, as a trade-off, a bending loss of the HF 10 is significantly high. For example, if the HF 10 is bent at bending radius of 5 m, then the bending loss is approximately 20 dB/m.

However, the diameter Rc of the HF 10 is 583 μm. The diameter Rc is significantly larger than or equal to the diameter of conventional optical fibers, which is 125 μm. Thus, the HF 10 has high stiffness, and the HF 10 does not bend easily when less than or equal to 3 m of the HF 10 is used. Therefore, the HF 10 does not create a bending loss and transmits light with a low loss when it is in use.

Detail of the present invention is further shown below. First, the diameter of the hard to bend HF of the present invention is shown. Second, calculation results of the HF in finite element method (FEM) simulation are shown. The HFs used in the calculation have the harder to bend diameters and the significantly larger effective core areas.

First, to study diameters of the hard to bend HF, the relationship between the diameter of HF and the force required to bend the HF is considered.

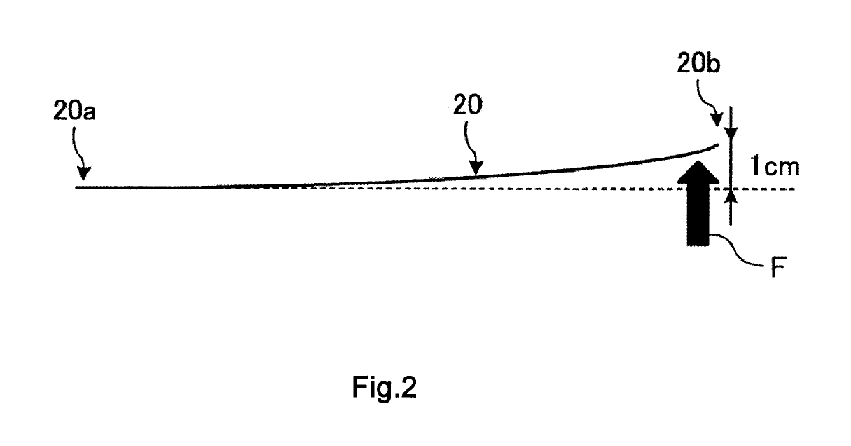

FIG. 2 shows a method to calculate the force required to bend the HF. In this calculation method, one end 20a of a HF 20 is fixed and a force is applied to the other end 20b perpendicular to the length direction of the HF 20. The HF 20 is 1 m in length and has the same cross-sectional structure as the HF 10 shown in FIG. 1. The force required to bend the HF is calculated as the force required to move the end 20b to 1 cm toward the direction of the force F. If total length of the HF 20 is bent at the same curvature, the bending radius is approximately 50 m.

If the diameter of the HF 20 is R_{C1} [μm], strain ε applied to the HF 20 due to bending can be expressed as follows:

ε=R_{C1}/(50×2)×10⁻⁶ (1)

The force σ [N] required to apply the strain ε onto the HF 20 can be expressed as follows:

σ=εE×π{(R_{C1}/2)²−(d/2)²×n}×10⁻¹² (2)

Where E is Young's modulus of the glass for the HF 20, and n is number of holes.

If the Young's modulus of the glass is 74 GPa, then equation (3) can be derived from equations (1) and (2).

σ=1.85R_{C1}(R_{C1}²−d²×n)π×10⁻¹⁰ (3)

For the HF having holes 13 in triangular lattice shapes as in the HF 10, if d/Λ is 0.42, then the diameter R_{H} of the outer most layer circumference of the holes 13 can be expressed as follows:

R_{H}=(2N+0.42)Λ (4)

Where N is number of hole layers.

In addition, for example, for securing the mechanical strength and restrictions in manufacturing, the diameter R_{C} is more than 10% larger than or equal to the diameter R_{H}. Therefore, the relationship can be expressed as follows:

R_{C}≧1.10R_{H} (5)

If the diameter R_{C} is exactly 10% larger than or equal to the diameter R_{H} in equation (5), then from equations (4) and (5), equation (3) can be expressed as follows:

σ=1.85×1.10{(2N+0.42)Λ}[{1.10(2N+0.42)Λ}²−(0.42Λ)²×n]π×10⁻¹⁰ (6)

This equation (6) can be applied to the HF 20.

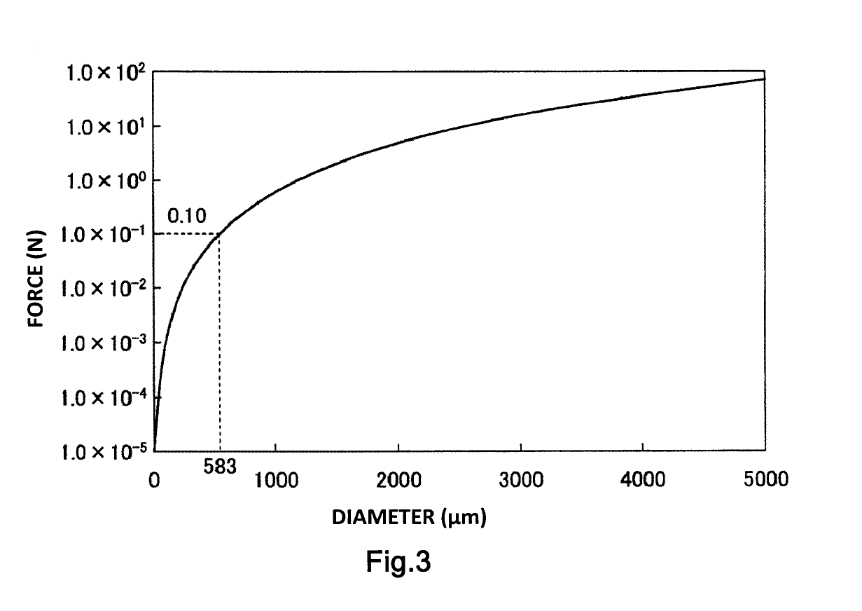

Next, FIG. 3 shows the relationship between the diameter of the HF 20 and the force required to bend the fiber. The relationship is calculated using equation (6). As shown in FIG. 3, if the diameter of the HF 20 is 583 μm, then the force required to bend the fiber 1 cm is 0.10 N. If the same force is applied when the HF is installed on a floor face or inside of a device, then the force is sufficiently large such that the force needs to be applied intentionally. Therefore, if the diameter of the HF 20 is larger than or equal to 583 μm, preferably larger than or equal to 1000 μm, then the HF does not bend easily when it is in use.

Consequently, because the diameter R_{c} of the HF 10 relating to the present first embodiment is 583 μm, even though the effective core area is significantly large, it does not cause a bending loss and can transmit light in low loss when it is in use.

Furthermore, because the diameter of the HF 10 is larger than or equal to 583 μm, even if the circumference surface of the cladding portion 12 is exposed to an outside, the HF 10 has sufficiently large mechanical strength. Therefore, a resin coating around the circumference of the HF 10 is not necessary. If the coating is not put on the HF 10, because the heat resistance is not limited to the heat resistance of the coating, the heat resistance of the HF without the coating is higher than that of the HF with the coating. Also, the circumference surface of the cladding portion 12 of the HF 10 can be water-cooled directly.

As described above, because the HF 10 has N=2 and Λ=120 μm, the diameter R_{H} is 530 μm. Also, if the diameter R_{c} is 10% larger than or equal to the diameter R_{H} in equation (5), then the diameter R_{c} is 583 μm.

Therefore, the HF 10 has a structure to expand the effective core area and to prevent the bending. In the HF 10, the diameter R_{C} can be larger than or equal to 583 μm.

Next, for HF having the same structure as the HF 10 shown in FIG. 1; the diameter, the confinement loss and the effective core area are calculated for different Λ. Then, range of A preferred in the present invention is shown. In calculation examples 1˜46 shown below, d/Λ is fixed at 0.42.

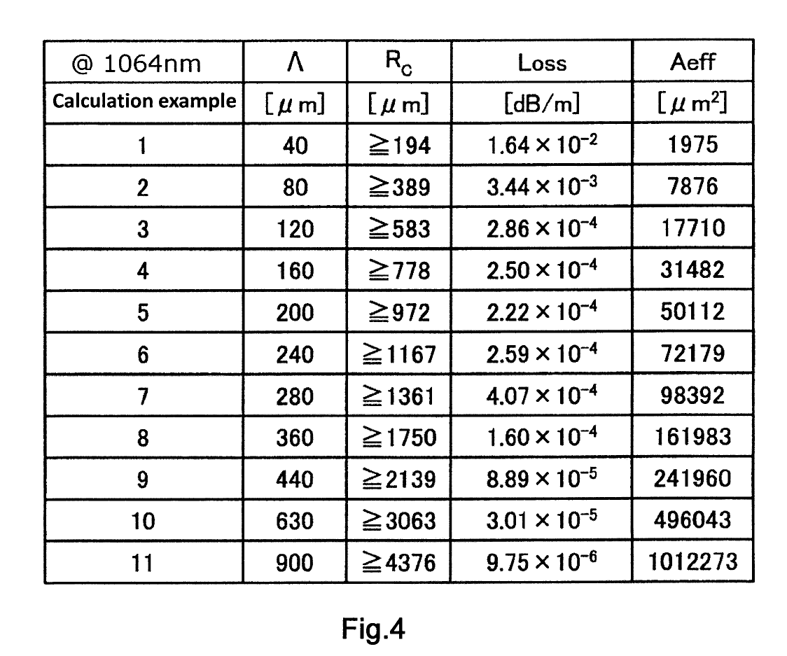

FIG. 4 shows the diameters R_{C}, the confinement losses, and the effective core areas of calculation examples 1˜11, which have the same HF structures as the HF 10 shown in FIG. 1. The confinement losses and the effective core areas are calculated at 1064 nm. Also, in FIG. 4, the diameter R_{C} is calculated from equations (4) and (5). In FIG. 4, “Loss” means the confinement loss, and “A_{eff}” means the effective core area. As shown in FIG. 4, for the HF having two hole layers, as shown in calculation examples 3˜11, if Λ is larger than or equal to 120 μm, then the HF can have the diameter R_{C} of larger than or equal to 583 μm, the effective core area of larger than or equal to 15000 μm², and the confinement loss of less than or equal to 0.1 dB/m.

Next, for the HF having the same structure as the HF 10 shown in FIG. 1 but having different number of hole layers (in particular 1, 3, 4 or 5 layers); the diameters, the confinement losses and the effective core areas are calculated for different Λ. As it is apparent from equation (6), the diameter of the HF, which requires 0.10 N to bend the HF by 1 cm is different for different number of holes and different number of hole layers. For example, if the number of hole layers in the HF is 1, 3, 4 and 5, then the number of holes is 6, 36, 60 and 90 respectively, and the diameter of the HF is 587 μm, 582 μm, 581 μm and 580 μm respectively.

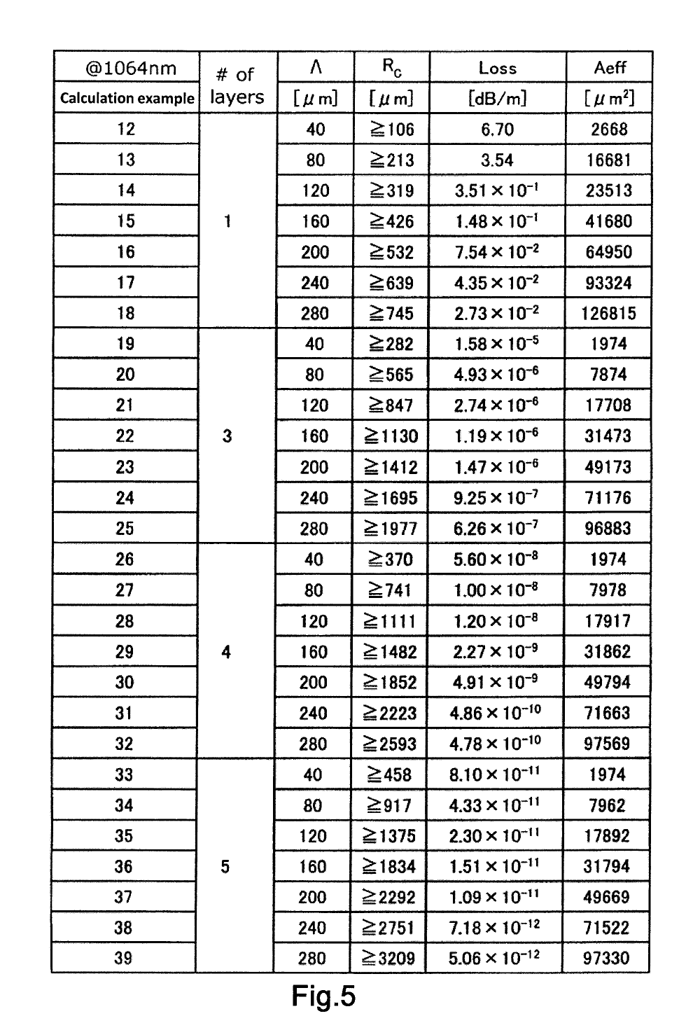

FIG. 5 shows the diameters R_{C}, the confinement losses, and the effective core areas of calculation examples 12˜39, which have the same HF structure as HF 10 shown in FIG. 1 but with different number of hole layers. The confinement losses and the effective core areas are calculated at 1064 nm. As shown in FIG. 5, for the HF having 1 hole layer, as shown in calculation examples 17 and 18, if Λ is larger than or equal to 221 μm, then the HF can have the diameter R_{C} larger than or equal to 587 μm, the effective core area larger than or equal to 15000 μm², and the confinement loss of less than or equal to 0.1 dB/m.

For the HF having 3 to 5 hole layers, as shown in calculation examples 21˜25, 28˜32 and 35˜39, if Λ is larger than or equal to 120 μm, then the HF can have the diameter R_{C} larger than or equal to 582 μm, 581 μm and 580 μm respectively, the effective core area larger than or equal to 15000 μm², and the confinement loss of less than or equal to 0.1 dB/m.

Next, for the HF having the same structure as the HF 10 shown in FIG. 1, the diameter, the confinement loss at 1550 nm and the effective core area are calculated for different Λ.

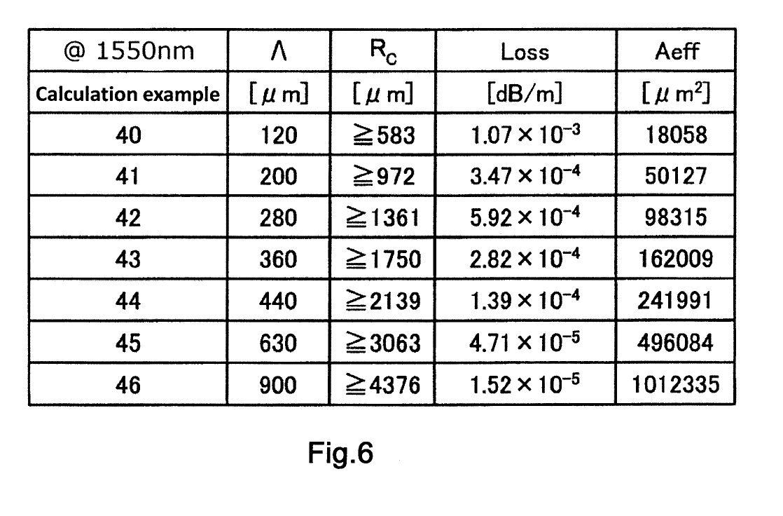

FIG. 6 shows the diameters R_{C}, the confinement losses at 1550 nm, and the effective core areas of calculation examples 40˜46, which have the HF structure shown in FIG. 1. As shown in FIG. 6, for the HF having two hole layers, as shown in calculation examples 40˜46, if Λ is larger than or equal to 120 μm, then the HF can have the diameter R_{C} larger than or equal to 583 μm, the effective core area larger than or equal to 15000 μm², and the confinement loss of less than or equal to 0.1 dB/m. Therefore, the HF having A shown in calculation examples 40˜46 have significantly large effective core areas and can transmit light at a low loss at 1550 nm, which is the most common wavelength used in optical communication.

In the above embodiments and calculation examples, d/Λ of the HF is 0.42; however, if d/Λ is less than or equal to 0.42, ESM can be realized. However, for stable hole structure during manufacturing, d/Λ is preferred to be more than 0.1.

The attenuation loss in transmission was measured for the following sample of two hole layer HF according to the present invention.

d=82 μm

Λ=203 μm

d/Λ=0.40

Fiber Length=1.2 m

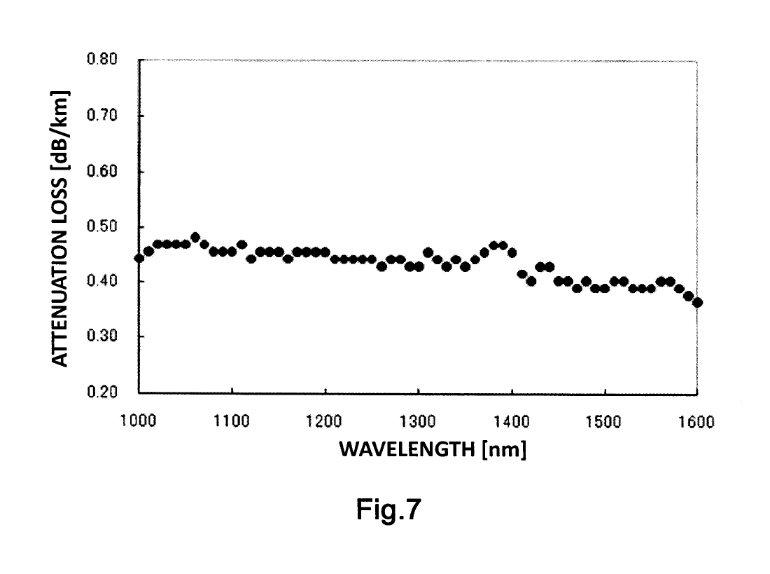

Aeff calculated by a simulation in the actual hole-structure was 51643 μm² at wavelength=1000 nm. The measured attenuation loss data measured by a cut-back method in a wavelength range of 1000 nm to 1600 nm is shown in FIG. 7.

As indicated in FIG. 7, for example, the attenuation loss values are 0.44 dB/m, 0.45 dB/m, 0.45 dB/m, 0.43 dB/m, 0.45 dB/m, 0.39 dB/m and 0.36 dB/m respectively at wavelength of 1000 nm, 1100 nm, 1200 nm, 1300 nm, 1400 nm, 1500 nm and 1600 nm.

What is claimed is:

1. A holey fiber comprising:
a core portion and;
a cladding portion at the circumference of the core portion, the cladding portion has plurality of holes distributed to shape triangular lattices around the core portion
wherein d/Λ is less than or equal to 0.42, the diameter of the holey fiber is larger than or equal to 580 μm, an effective core area is larger than or equal to 15000 μm² at 1064 nm and a confinement loss is than 0.1 dB/m at 1064 nm where d is the hole diameter in μm and Λ is a lattice constant of the triangular lattice in μm.

2. The holey fiber of claim 1, wherein the Λ is larger than or equal to 120 μm.

3. The holey fiber of claim 1, wherein the circumference surface of the cladding portion is exposed to an outside.
